(19) United States
(12) Patent Application Publication
(10) Pub. No.: US 2018/0117867 A1
(43) Pub. Date: May 3, 2018

(54) Shoe Sole with Shoe Nails Made of Different Materials

(71) Applicant: Teng-Jen YANG, Taichung City (TW)

(72) Inventor: Teng-Jen YANG, Taichung City (TW)

(21) Appl. No.: 15/853,341

(22) Filed: Dec. 22, 2017

Related U.S. Application Data
(63) Continuation-in-part of application No. 14/522,587, filed on Oct. 24, 2014.

(51) Int. Cl. B29D 35/12; A43B 13/26; B29D 35/14

(52) U.S. Cl. CPC B29D 35/122; A43B 13/26; B29L 2031/504; B29K 2715/006; B29D 35/148

(57) ABSTRACT

A shoe sole with shoe nails made of different materials includes: a base made of a first material and including a plurality of connecting portions each having at least three connecting surfaces, at least two connecting surfaces have different slopes and are connected to each other. The shoe nails are formed on the connecting portions, and the shoe nails are equal in quantity to the connecting portions. Each connecting portion has a shoe nail, each shoe nail includes: an abutting portion formed in the shape of the connecting portions, and an opposite exposed portion which is a flat surface used for stepping on a floor. The abutting portion includes at least three abutting surfaces, at least two abutting surfaces have different slopes and are connected to each other, and each abutting surface is abutted against a corresponding connecting surface with a corresponding slope.

This application is a continuation in part of U.S. patent application Ser. No. 14/522,587 which claims the benefit of the earlier filing date of Oct. 24, 2014. The entire specification of which is incorporated herein by reference.

### BACKGROUND

### Field of the Invention

The present invention relates to a shoe sole with shoe nails, and more particularly to a shoe sole with shoe nails made of different materials.

### Related Prior Art

Normally, shoe nails bonded to a shoe sole can be classified into same material bonding and different material bonding. The same material bonding means that the material of the shoe nails is the same as that of the shoe sole, and the different material bonding means that the material of the shoe nails is different from that of the shoe sole. The shoe sole is easy to manufacture but has less grip, when the material of the shoe nails is the same as that of the shoe sole.

When the material of the shoe nails is different from that of the shoe sole, the shoe nails might be made of metal or rubber. When made of metal, the shoe nails are mostly screwed to the shoe sole. When made of other materials, the shoe nails can be bonded to the shoe sole by composite molding. With the composite molding, however, the material of the shoe nails is covered by the material of the shoe sole without being exposed outside. For example, when the shoe sole is made of plastic and the shoe nails are made of rubber, the rubber will be hidden in the plastic without being exposed outside. In this way, the antiskid performance of the shoe nails is not enough to cope with high intensity activities.

To overcome the above disadvantages, we have a shoe sole 90 with exposed shoe nails made of a different material 99 from the shoe sole 90, as shown in FIG. 1, wherein the different material 99 is only bonded to a part of the shoe sole 90 that comes into contact with the ground, in other words, the different material 99 is only bonded to a single surface of the shoe sole 90, therefore, the bonding effect is not stable and unable to resist the lateral external force, causing peeling off of the different material. Hence, a shoe sole with different-material made shoe nails which are firmly bonded and have great antiskid properties is urgently needed.

### SUMMARY

One objective of the present invention is to provide a shoe sole with shoe nails made of different materials capable of improving the bonding between the shoe sole and the shoe nails and providing excellent antiskid properties.

To achieve the above objective, a shoe sole with shoe nails made of different materials in accordance with the invention comprises:

a base made of a first material and including a plurality of connecting portions, wherein each of the connecting portions includes at least three connecting surfaces, at least two of the connecting surfaces have different slopes and are connected to each other; and

the shoe nails made of a second material different from the first material and formed on the connecting portions, and quantity of the shoe nails is equal to that of the connecting portions, each of the connecting portions having a corresponding one of the shoe nails, each of the shoe nails including: an abutting portion formed in the shape of the connecting portions, and an opposite exposed portion which is a flat surface used for stepping on a floor, wherein the abutting portion includes at least three abutting surfaces, at least two of the abutting surfaces have different slopes and are connected to each other, and each of the abutting surfaces is abutted against a corresponding one of the connecting surfaces with a corresponding slope.

It can be learned from the above description that the shoe nails which are made of a different material from the base are coupled to the base by composite molding, without having to screwing the shoe nails to the shoe sole. Besides, the exposed portion of each of the shoe nails is exposed outside the base to improve antiskid properties. Each of the connecting portions includes at least three connecting surfaces, and at least two of the connecting surfaces have different slopes and are connected to each other. Each of the abutting portions includes at least three abutting surfaces, and at least two of the abutting surfaces have different slopes and are connected to each other. Each of the abutting surfaces is abutted against a corresponding one of the connecting surfaces that has a corresponding slope. By such arrangements, the adhesion between the base and the shoe nails is substantially improved and great enough to resist the external force in the horizontal direction, thus preventing the falling of the shoe nails.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a cross sectional view of a conventional shoe sole with shoe nails made of different materials;

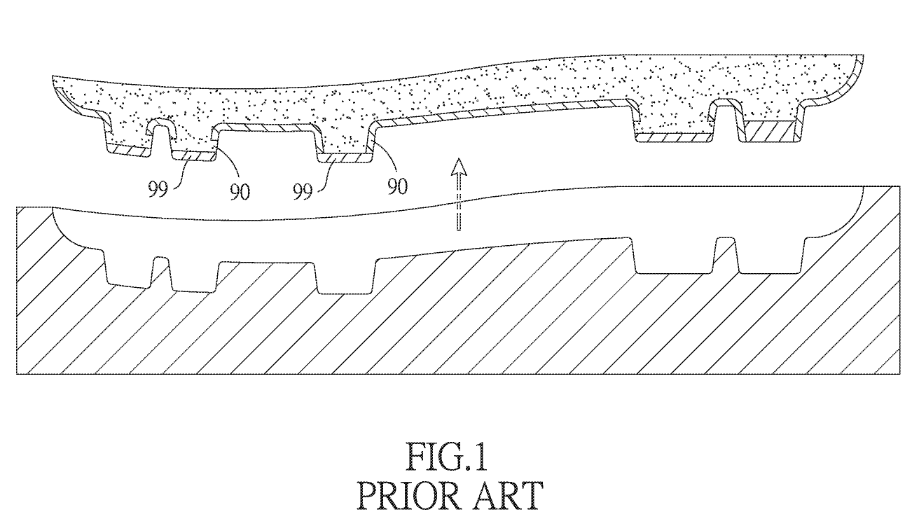

FIG. 2 is a cross sectional view showing a shoe sole with shoe nails made of different materials in accordance with a preferred embodiment of the invention;

FIG. 3 is a cross sectional view showing a shoe sole with shoe nails made of different materials in accordance with a preferred embodiment of the invention; and

FIG. 4 is a cross sectional view showing a shoe sole with shoe nails made of different materials in accordance with another preferred embodiment of the invention.

### DETAILED DESCRIPTION

The present invention will be clearer from the following description when viewed together with the accompanying drawings, which show, for purpose of illustrations only, the preferred embodiment in accordance with the present invention.

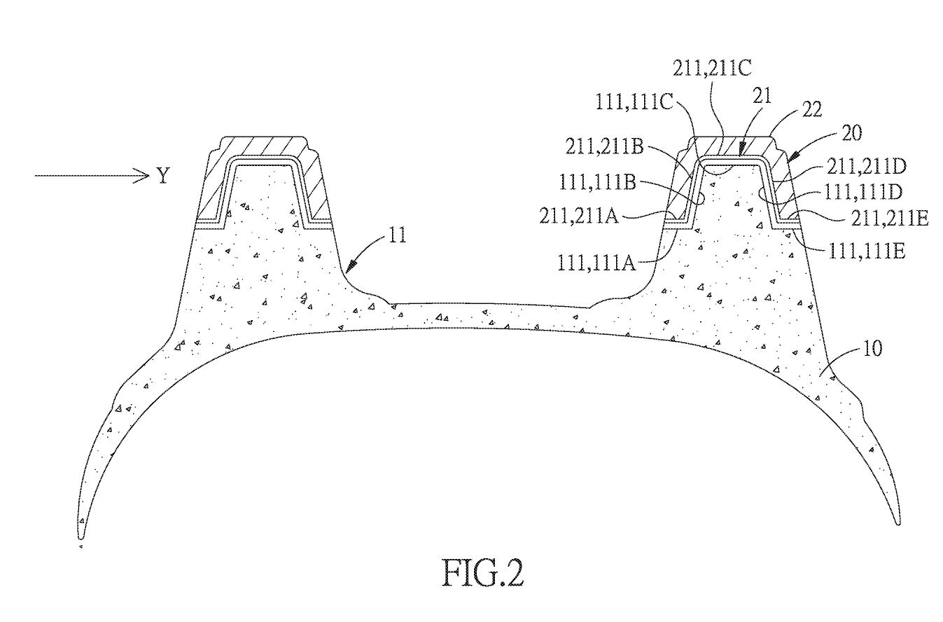

Referring to FIGS. 2-4, a shoe sole with shoe nails made of different materials in accordance with the preferred embodiment of the invention, comprises: a base 10 and a plurality of shoe nails 20.

The base 10 is made of a first material and includes a plurality of connecting portions 11. Each of the connecting portions 11 includes at least three connecting surfaces 111. The connecting surfaces 111 are not limited to flat surfaces and can also be curved surfaces, and at least two of the connecting surfaces 111 have different slopes and are connected to each other. It is to be noted that, when the connecting surfaces 111 are curved surfaces, the tangent slope of each point on the curved surfaces is different, and the slope of a curved surface is therefore naturally different from that of a flat surface.

The shoe nails 20 are made of a second material which is different from the first material, and are formed on the connecting portions 11. The quantity of the shoe nails 20 is equal to the quantity of the connecting portions 11. Namely, each connecting portion 11 has a shoe nail 20. Each of the shoe nails 20 includes: an abutting portion 21 formed in the shape of the connecting portions 11, and an opposite exposed portion 22 which is a flat surface exposed outside the base 10 and used for stepping on the ground. The abutting portion 21 includes at least three abutting surfaces 211 which are not limited to flat surfaces and can also be curved surfaces. At least two of the abutting surfaces 211 have different slopes and are connected to each other. Each of the abutting surfaces 211 is abutted against a corresponding one of the connecting surfaces 111 that has a corresponding slope.

Preferably, the connecting portion 11 and the abutting portion 21 can be one of the following three types (only one connecting portion 11 and one abutting portion 21 are recited for easy explanation): suppose that the floor that the shoe nails 20 step on has a zero slope, and the direction along which the floor extends is a horizontal direction Y. The first type: one of the connecting surfaces 111 of the connecting portion 11 is an arc-shaped surface, and one of the abutting surfaces 211 of the abutting portion 21 is an arc-shaped; the second one: one of the connecting surfaces 111 has a positive slope, another of the connecting surfaces 111 has a negative slope, one of the abutting surfaces 211 has a positive slope, and another of the abutting surfaces 211 has a negative slope; the third one: at least two of the connecting surfaces 111 have an infinite slope, and at least two of the abutting surfaces 211 have an infinite slope, so that the connecting portion 11 and the abutting portion 21 are partially overlapped in the horizontal direction Y to resist the external force along the horizontal direction Y, and thus the shoe nails 20 can be bonded more firmly to the base 10.

In the embodiment shown in FIG. 2, the connecting portion 11 is provided with five connecting surfaces 111, the abutting portion 21 is provided with five abutting surfaces 211, and the connecting surfaces 111 from the left to the right of FIG. 2 are defined as a first connecting surface 111A, a second connecting surface 111B, a third connecting surface 111C, a fourth connecting surface 111D and a fifth connecting surface 111E. The first, third and fifth connecting surfaces 111A, 111C and 111E each have a zero slope, the second connecting surface 111B has a positive slope, and the fourth connecting surface 111D has a negative slope. The respective abutting surfaces 211 from the left to the right of FIG. 2 are defined as a first abutting surface 211A, a second abutting surface 211B, a third abutting surface 211C, a fourth abutting surface 211D and a fifth abutting surface 211E. The first, third and fifth abutting surface 211A, 211C, 211E each have a zero slope, the second abutting surface 211B has a positive slope, and the fourth abutting surface 211D has a negative slope. By such arrangements, the connecting portion 11 has a convex shape, and the abutting portion 21 has a concave shape, so that the connecting portion 11 and the abutting portion 21 are engaged with each other and have overlapped portion in the horizontal direction Y so as to resist the external force in the horizontal direction Y, which allows the shoe nails 20 to be bonded more firmly to the base 10.

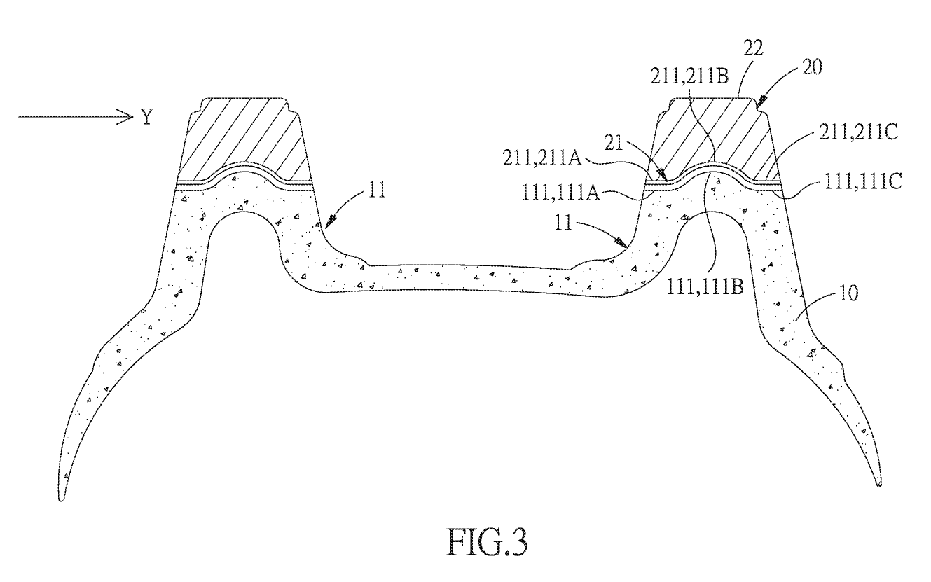

FIG. 3 shows another embodiment of the invention, wherein the connecting portion 11 is provided with three connecting surfaces 111, the abutting portion 21 is provided with three abutting surfaces 211, and the connecting surfaces 111 from the left to the right of FIG. 3 are defined as a first connecting surface 111A, a second connecting surface 111B, and a third connecting surface 111C. The first and third connecting surfaces 111A, 111C each have a zero slope, and the second connecting surface 111B is an arc-shaped surface. The respective abutting surfaces 211 from the left to the right of FIG. 3 are defined as a first abutting surface 211A, a second abutting surface 211B, and a third abutting surface 211C. The first and third abutting surface 211A, 211C each have a zero slope, the second abutting surface 211B is an arc-shaped surface. By such arrangements, the connecting portion 11 has a convex shape, and the abutting portion 21 has a concave shape, so that the connecting portion 11 and the abutting portion 21 are engaged with each other and have overlapped portion in the horizontal direction Y so as to resist the external force in the horizontal direction Y, which allows the shoe nails 20 to be bonded more firmly to the base 10.

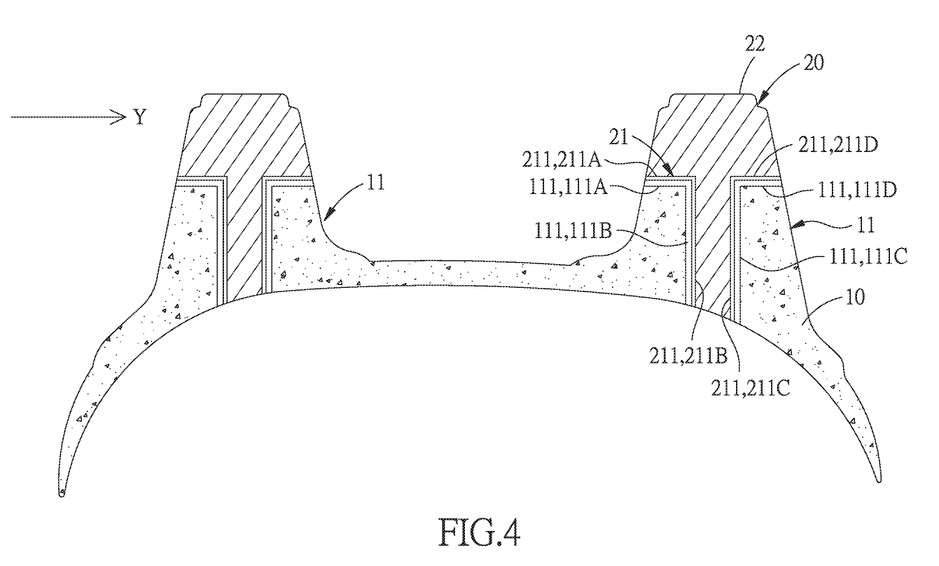

FIG. 4 shows another embodiment of the invention, wherein the connecting portion 11 is provided with four connecting surfaces 111, the abutting portion 21 is provided with four abutting surfaces 211, and the connecting surfaces 111 from the left to the right of FIG. 4 are defined as a first connecting surface 111A, a second connecting surface 111B, a third connecting surface 111C, and a fourth connecting surface 111D. The first and fourth connecting surfaces 111A, 111D each have a zero slope, and the second and third connecting surfaces 111B, 111C each have an infinite slope. The respective abutting surfaces 211 from the left to the right of FIG. 4 are defined as a first abutting surface 211A, a second abutting surface 211B, a third abutting surface 211C, and a fourth abutting surface 211D. The first and fourth abutting surface 211A, 211D each have a zero slope, and the second and third abutting surfaces 211B, 211C each have an infinite slope. By such arrangements, the connecting portion 11 has a convex shape, and the abutting portion 21 has a concave shape, so that the connecting portion 11 and the abutting portion 21 are engaged with each other and have overlapped portion in the horizontal direction Y so as to resist the external force in the horizontal direction Y, which allows the shoe nails 20 to be bonded more firmly to the base 10.

It can be learned from the above description that the shoe nails 20 which are made of a different material from the base 10 are coupled to the base 10 by composite molding. Besides, the exposed portion 22 of each of the shoe nails 20 is exposed outside the base 10 to improve antiskid properties. Each of the connecting portions 11 includes at least three connecting surfaces 111, and at least two of the connecting surfaces 111 have different slopes and are connected to each other. Each of the abutting portions 21 includes at least three abutting surfaces 211, and at least two of the abutting surfaces 211 have different slopes and are connected to each other. Each of the abutting surfaces 211 is abutted against a corresponding one of the connecting surfaces 111 that has a corresponding slope. By such arrangements, the adhesion between the base 10 and the shoe nails 20 is substantially improved and great enough to resist the external force in the horizontal direction Y, thus preventing the falling of the shoe nails 20.

While we have shown and described various embodiments in accordance with the present invention, it is clear to those skilled in the art that further embodiments may be made without departing from the scope of the present invention.

What is claimed is:

1. A shoe sole with shoe nails made of different materials, comprising:
a base made of a first material and including a plurality of connecting portions, wherein each of the connecting portions includes at least three connecting surfaces, at least two of the connecting surfaces have different slopes and are connected to each other; and
the shoe nails made of a second material different from the first material and formed on the connecting portions, and quantity of the shoe nails is equal to that of the connecting portions, each of the connecting portions having a corresponding one of the shoe nails, each of the shoe nails including: an abutting portion formed in the shape of the connecting portions, and an opposite exposed portion which is a flat surface used for stepping on a floor, wherein the abutting portion includes at least three abutting surfaces, at least two of the abutting surfaces have different slopes and are connected to each other, and each of the abutting surfaces is abutted against a corresponding one of the connecting surfaces with a corresponding slope.

2. The shoe sole as claimed in claim 1, wherein the floor that the shoe nails step on has a zero slope, a direction along which the floor extends is a horizontal direction, one of the connecting surfaces of the connecting portion is an arc-shaped surface, and one of the abutting surfaces of the abutting portion is an arc-shaped, so that each of the connecting portions is overlapped with a corresponding one of the abutting portions in the horizontal direction.

3. The shoe sole as claimed in claim 1, wherein the floor that the shoe nails step on has a zero slope, a direction along which the floor extends is a horizontal direction, one of the connecting surfaces has a positive slope, another of the connecting surfaces has a negative slope, one of the abutting surfaces has a positive slope, and another of the abutting surfaces has a negative slope, so that each of the connecting portions is overlapped with a corresponding one of the abutting portions in the horizontal direction.

4. The shoe sole as claimed in claim 1, wherein the floor that the shoe nails step on has a zero slope, a direction along which the floor extends is a horizontal direction, at least two of the connecting surfaces have an infinite slope, and at least two of the abutting surfaces have an infinite slope, so that each of the connecting portions is overlapped with a corresponding one of the abutting portions in the horizontal direction.

5. The shoe sole as claimed in claim 2, wherein each of the connecting portions is provided with three connecting surfaces, each of the abutting portions is provided with three abutting surfaces, the connecting surfaces are defined as a first connecting surface, a second connecting surface and a third connecting surface, the first and third connecting surfaces each have a zero slope, the second connecting surface is an arc-shaped surface, the abutting surfaces are defined as a first abutting surface, a second abutting surface and a third abutting surface, the first and third abutting surface each have a zero slope, and the second abutting surface is an arc-shaped surface.

6. The shoe sole as claimed in claim 3, wherein each of the connecting portions is provided with five connecting surfaces, each of the abutting portions is provided with five abutting surfaces, the connecting surfaces are defined as a first connecting surface, a second connecting surface, a third connecting surface, a fourth connecting surface and a fifth connecting surface, the first, third and fifth connecting surfaces and each have a zero slope, the second connecting surface has a positive slope, and the fourth connecting surface has a negative slope, the respective abutting surfaces are defined as a first abutting surface, a second abutting surface, a third abutting surface, a fourth abutting surface and a fifth abutting surface, the first, third and fifth abutting surface each have a zero slope, the second abutting surface has a positive slope, and the fourth abutting surface has a negative slope.

7. The shoe sole as claimed in claim 4, wherein each of the connecting portions is provided with four connecting surfaces, each of the abutting portions is provided with four abutting surfaces, the connecting surfaces are defined as a first connecting surface, a second connecting surface, a third connecting surface and a fourth connecting surface, the first and four connecting surfaces each have a zero slope, the second and third connecting surfaces each have an infinite slope, the respective abutting surfaces are defined as a first abutting surface, a second abutting surface, a third abutting surface and a fourth abutting surface, and the first and fourth abutting surface each have a zero slope, and the second and third abutting surfaces each have an infinite slope.
